(19) United States
(12) Patent Application Publication
(10) Pub. No.: US 2001/0050809 A1
(43) Pub. Date: Dec. 13, 2001

(54) Microscope, microscope unit and method for manufacturing microscope unit

(75) Inventors: Nobuyuki Miyake, Hiratuka-shi (JP); Kazumasa Aoyama, Kawasaki-shi (JP)

Correspondence Address: STAAS & HALSEY LLP, 700 11TH STREET, NW, SUITE 500, WASHINGTON, DC, 20001, US

(73) Assignee: NIKON CORPORATION, Tokyo (JP)

(21) Appl. No.: 09/866,744

(22) Filed: May 30, 2001

(30) Foreign Application Priority Data
Jun. 6, 2000 (JP) 2000-169567

(51) Int. Cl. G02B 21/36; G02B 21/00

(52) U.S. Cl. 359/381; 359/369

(57) ABSTRACT

A microscope includes a body unit that constitutes a microscope body and a plurality of units that are attached to the body unit. The plurality of units are electrically connected to a ground line. In this microscope, at least two of the units are imparted with conducting properties with conducting abilities different from each other.

### BACKGROUND OF THE INVENTION

1. Field of the Invention

This invention relates to a microscope that is constructed by attaching a plurality of units, including a lens unit for mounting a lens and a support unit for supporting a sample to be examined, to a main body unit that constitutes a body of the microscope. The invention also relates to a microscope system that includes the microscope mentioned above and a microscope unit manufacturing method for manufacturing units of a microscope.

2. Related Background Art

Microscopes are used not only for observation of cells or minerals but also for industrial purposes, that is, for examining precision industrial components.

Some industrial components such as semiconductor wafers or magnetic heads have such a low withstand voltage that they are broken only by a small current flowing therethrough.

Upon examination of an electronic component with a microscope, static electricity or charge that is built up in the components of the microscope or the body of the examiner (or microscope user) can flow into the microscope. So, some measure is required to prevent electronic components with low withstand voltage from being broken. (The break of a component due to the above-mentioned cause will be referred to as “an electrostatic break” hereinafter.)

Specifically, the electrostatic break would occur under following situations (1) and (2), where reference is made to FIG. 5, which is an overall view of a conventional microscope apparatus 100.

(1) Upon examination, a sample to be examined 101A is placed onto a stage portion 101 of the microscope apparatus 100. If one of the stage portion 101, the microscope apparatus 100 and the sample 101A itself is electrostatically charged at the time of placing the sample 101A onto the stage portion 101, a current will flow through the sample 101A at the moment when the sample 101A is placed on the stage portion to cause the electrostatic break.

(2) During examination, the examiner 200 sometimes touches some parts of the microscope apparatus 100 with his or her fingers or hands to perform various operations (e.g. operations for moving the stage portion 101, changing setting of the microscope apparatus 100, and switching lens magnification etc.). So if the examiner 200 is electrostatically charged, a current will flow into the sample to be examined 101A via the examiner 200 and a contact between the microscope apparatus 100 and the examiner to cause the electrostatic break. Furthermore, if some part of the microscope apparatus 100 is electrostatically charged at the time of the above-mentioned operations by the examiner, a current will flow into the sample to be examined 101A via the microscope apparatus 100 to cause the electrostatic break.

In view of the above, the user of the microscope apparatus 100 has to perform an operation for eliminating static electricity from the stage portion 101, the sample to be examined 101A etc. before placing the sample on the stage portion 101.

The most common way of providing the microscope apparatus 100 with a function for preventing electrostatic break is connecting ground lines 201 to the parts of the microscope apparatus 100 so as to prevent a current from flowing into the sample to be examined 101A even if a current is generated in some part of the microscope apparatus 100. In addition, in order to directing the current generated in the microscope apparatus 100 to the ground lines 201 with reliability, conductive materials are used for making the microscope apparatus 100. In this connection, as the conductive materials, metals with high conductivity, conductive plastics, conductive coatings or plating etc. are used. Japanese Patent Application Laid-Open No. 9-506719 suggests the use of well-known a plastic material that is rendered conductive by using static charge dissipating material.

By the way, in some cases, such as in examining plural kinds of electronic components, different kinds of samples to be examined 101A may differ in maximum allowable amount of current (hereinafter referred to as “electrostatic tolerance”) that does not cause the electrostatic break.

So upon examining samples to be examined 101A having different electrostatic tolerances, users have attempted, in order to vary electrostatic break preventing function of the microscope apparatus 100, various modifications of the microscope apparatus 100, such as changing the wiring of said ground lines 201, changing the number of the ground lines 201, or inserting a capacitor(s) in the ground lines, by trial and error.

For example, as a result of a modification, as shown in FIG. 5, ground lines are connected to plural parts of the microscope apparatus 100, in which the ground line 201 connected to the stage portion 101 with which the current should be delayed is inserted with a capacitor 201a. In some cases, the ground line 201 is connected to the examiner 200 in order that a current may not flow from the examiner to the microscope apparatus 100 and the sample to be examined 101A.

However, in the above-described microscope apparatus 100, the plurality of ground lines 201 would interfere operations of the examiner or can catch the examiner's hand or leg to cause the microscope apparatus 100 to topple over.

Furthermore, since the modifications of the microscope apparatus 100 was very difficult task involving a long time and trial and error, the operator sometimes could not attain satisfactory modification so that electrostatic break of the sample to be examined 101A was caused.

Since frequency of examining more various samples is expected to increase with the development of electronic components in the future, it is desired that the electrostatic break preventing function of the microscope apparatus be accommodated flexibly and reliably to the electrostatic tolerance of each of the samples to be examined.

### SUMMARY OF THE INVENTION

The first invention was made in view of the above-mentioned problems and its object is to provide a microscope that can prevent electrostatic break of a sample to be examined with reliability by determining conducting ability of each unit in accordance with electrostatic tolerance of the sample to be examined while suppressing the number of ground lines.

An object of the second invention is to provide a microscope system in which the electrostatic break preventing function of the microscope can be flexibly and reliably accommodated to the electrostatic tolerance of a sample to be examined.

An object of the third invention is to provide a method for manufacturing microscope units that realizes the microscope and microscope system mentioned above for certain.

A microscope according to the first aspect of the first invention comprises a body unit that constitutes a body of the microscope and a plurality of units attached to the body unit and connected to a ground line, wherein at least two of said units have conducting properties with conducting abilities different from each other.

In this connection, in this specification, the term “conducting property” is used to indicate such a property of a unit that can reduce, when a predetermined voltage is applied to the unit externally, the internal potential to a predetermined level that is sufficiently low within a predetermined time, under a condition in which the unit is grounded. On the other hand, the term “conducting ability” is used to indicate quickness in reducing the internal potential of a unit, when a predetermined voltage is applied to the unit, to a predetermined value that is sufficiently low, under a condition in which the unit is grounded (i.e. shortness in potential decay time).

As per the above, if at least two units have conducting properties and these units are electrically connected to a ground line, the microscope itself is given electrostatic break preventing function.

A microscope according to the second aspect of the first invention may be characterized by that in the microscope according to the first aspect, a support unit that supports a sample to be examined is provided as one of said plurality of units, wherein the support unit is one of the two unit that have conducting properties and its conducting ability is lower than that of the other unit.

Generally, abrupt elimination of static electricity (or charge) generated in a sample to be examined will result in electrostatic break of the sample. But in this microscope, the support unit that supports the sample to be examined has conducting property and its conducting ability is set lower than that of the other unit. Therefore, if the support unit is electrically connected to a ground line, the static electricity in the sample to be examined can flow into the support unit gently, so that the charge in the sample to be examined can be eliminated while preventing the electrostatic break of the sample.

A microscope according to the third aspect of the first invention may be characterized by that in the microscope according to the second aspect described above, said support unit is a holder for holding the sample to be examined and the conducting ability of that holder is so arranged that its decay time falls within the range of 0.2 to 5 seconds while the conducting ability of said other unit is so arranged that its decay time is not more than 0.2 second.

With the above arrangement, electrostatic electricity in the sample to be examined can be caused, only by electrically connecting the holder to the ground line via said other unit, to flow into the holder side at a sufficiently mild rate with reliability, and then flow into said other unit and the ground at high rate.

A microscope according to the fourth aspect of the first invention may be characterized by that in the microscope according to the first aspect, a movable unit that is adapted to be adjustable or detachable is provided as one of said plurality of units, wherein said movable unit is one of said two units that have conducting properties and its conducting ability is higher than that of the other unit.

Since it is probable that the examiner's fingers or hands touch such a movable unit directly, the possibility of static electricity generation therein is high. Therefore high conducting ability is required for it.

If the conducting ability of the movable unit is made relatively high and the conducting ability of the other unit is relatively low, as is the case with this microscope, unnecessary cost in providing electrostatic break preventing function can be suppressed, since necessary conducting ability is imparted to the part that needs to have such conducting ability.

In this connection, in ordinary microscopes, the lens unit is generally constructed as a detachable and movable unit. On the other hand, in the microscope that is provided with a stage unit, the stage unit is generally constructed as a movable unit that is adjustable in its position. In these cases, it would be desirable to design the lens unit and the stage unit respectively to have relatively high conducting ability.

A microscope according to the fifth aspect of the first invention may be characterized by that in the microscope according any of the first to fourth aspects, said two units that have conducting properties are electrically connected to each other, and a ground line is connected to only one of the two units.

As a result of the above feature of the fifth aspect, both of the units can be grounded. Thus it is possible to reduce the number of ground lines or even to minimize the number to one by utilizing not only ground lines but also the conducting abilities of the units and the electrical connections between the units upon providing electrostatic break preventing function. Then, troublesome task of connecting many ground lines and the risk of entangling the examiner's hand or leg in ground lines can be reduced.

A microscope according to the second invention comprises a body unit that constitutes a body of the microscope and a plurality of units attached to the body unit, wherein a support unit for supporting a sample to be examined is provided as one of said plurality of units, and an replacement (or interchangeable) unit having a structure same as the support unit is further provided, wherein the support unit and the replacement unit have conducting properties with respective conduction abilities different from each other.

In this microscope system, the electrostatic break preventing function of the microscope can be varied only by exchanging the replacement unit and the support unit. Namely, if a plurality of replacement units are prepared in advance and an replacement unit with an appropriate conducting ability is selected in accordance with the electrostatic tolerance of the sample to be examined, it is possible to accommodate the microscope to the electrostatic tolerance of the sample to be examined flexibly and reliably.

A method for manufacturing microscope units according to the third invention is a method for manufacturing two microscope units having conducting properties with conducting abilities different from each other, comprising making unit bodies of said two units through a predetermined process, and imparting conduction ability to each of the units, wherein conduction abilities of the units are made different from each other by one of the following manners: selecting kinds of conductor materials used for the unit bodies, selecting kinds of conductor materials used for coatings of the unit bodies, controlling a mixture ratio of a conductor material and a non-conductor material to be mixed to materials of the unit bodies, controlling a mixture ratio of a conductor material and a non-conductor material to be mixed to materials of coatings of the unit bodies, selecting kinds of conductor material and non-conductor material to be mixed to materials of the unit bodies, selecting kinds of conductor material and non-conductor material to be mixed to materials of coatings of the unit bodies, and controlling thickness of coatings of unit bodies.

According to the method of the third invention, it is possible to impart predetermined different conducting abilities to the respective two units with reliability.

According to the first to fourth aspects of the first invention, it is possible to determine the conducting ability of each unit in accordance with the electrostatic tolerance of a sample to be examined. Therefore, a microscope that can reliably prevent electrostatic break of the sample can be realized.

According to the fifth aspect of the first invention, a microscope with the reduced number of ground lines can be realized.

According to the second invention, such a microscope system can be realized that can accommodate electrostatic break preventing function of the microscope to electrostatic tolerance of a sample to be examined flexibly and with reliability.

According to the third invention, the above mentioned microscopes and microscope system can be certainly realized.

### BRIEF DESCRIPTION OF THE DRAWINGS

FIG. 1 is a drawing showing an external appearance of a microscope system according to the first and second embodiments of the invention.

FIG. 2 is a drawing illustrating the constitution of the microscope system according to the first and second embodiments of the invention.

FIGS. 3(1), 3(2)A, 3(2)B and 3(2)C are diagrams explaining conducting abilities of units.

FIG. 4 is a table for summarizing ways of obtaining respective conducting abilities in the third embodiment.

FIG. 5 is a drawing showing an overall construction of a conventional microscope apparatus.

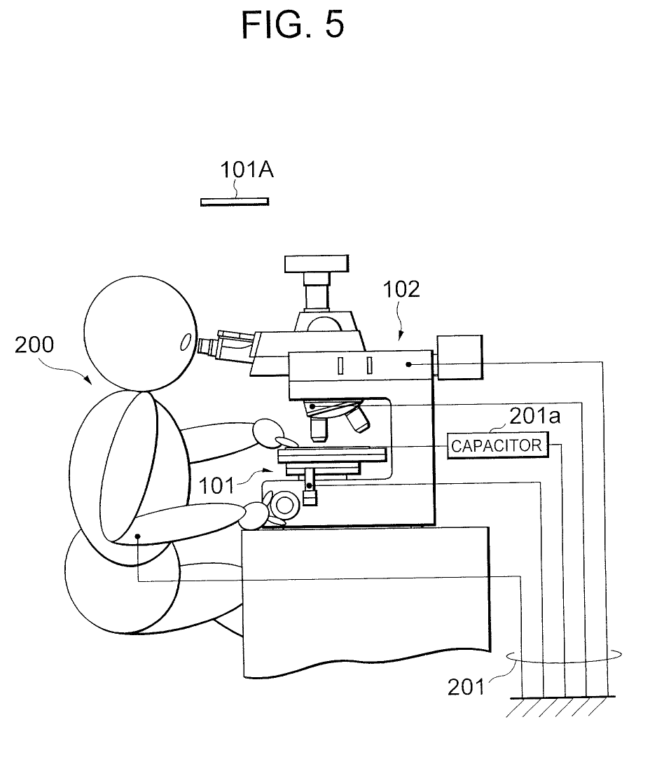

### DETAILED DESCRIPTION OF THE PREFERRED EMBODIMENTS

<First Embodiment>

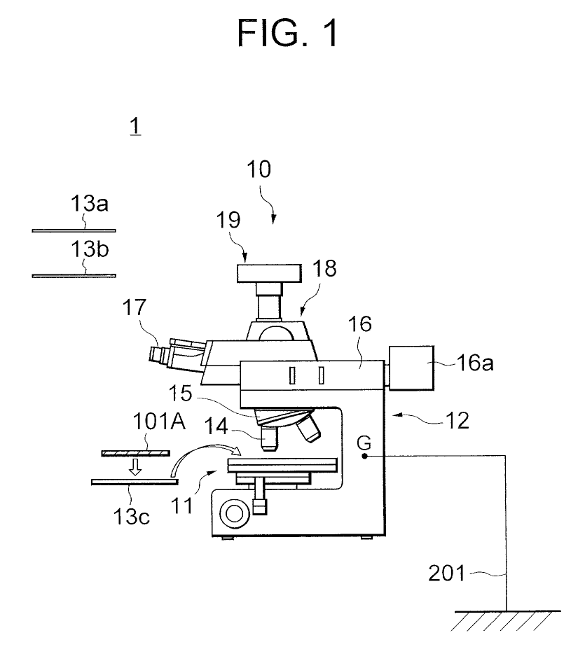

The first embodiment will be described with reference to FIGS. 1 to 4.

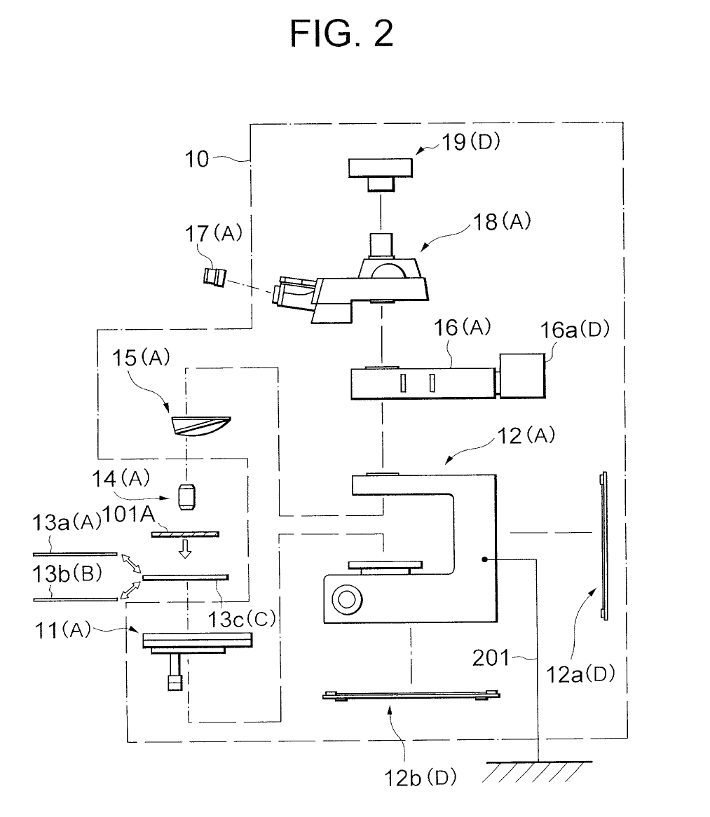

FIG. 1 is a drawing showing an external appearance of a microscope system 1 of the first embodiment as well as the second embodiment described later. FIG. 2 is a drawing illustrating a constitution of the microscope system according to the first and second embodiments.

As shown in Fig.1, the microscope system 1 comprises a microscope apparatus 10 composed of respective units described later, and various units such as an eyepiece 17 and an object lens 14 both of which are attachable/detachable to/from the microscope apparatus 10 and a holder 13 for fixing a sample to be examined 101A.

First, the units of the microscope apparatus 10 will be described. The microscope apparatus 10 comprises a microscope body 12, a stage unit 11 on which the sample to be examined 101A is to be placed, a revolver 15 attached to the microscope body 12, to which the object lenses are fitted, an illumination device 16 for illuminating a portion to be examined of the sample 101A, a barrel unit 18 attached to the microscope body 12, to which the eyepiece 17 is fitted, and a camera unit 19 for picking up an image formed by the object lens 14 etc. Incidentally, the sample to be examined 101A is placed on the stage unit 11 in a state in which it is fixed by the holder 13c (or 13a or 13b (described later)).

In the microscope apparatus 10 according to this embodiment, a ground line 201 is connected to point G of the microscope body 12. This ground line 201 connected to point G is only one ground line used in the microscope apparatus according to this embodiment.

As shown in FIG. 2, the respective units (i.e. stage unit 11, microscope body 12, holder 13, revolver 15, illumination device 16, barrel 18 and camera unit 19) of the microscope apparatus 10 are assembled together by means of specific connectors that have conductivities. As will be described later, each of these units has conducting property, so that as a result of the assembling, each unit of the microscope 10 and said ground line 201 are electrically connected to each other.

The object of adopting such a unit structure for the microscope apparatus 10 is to customize the microscope 10 by selecting units having desired specifications to meet requirements (for example, selecting an illumination unit that has specifications suitable for a specific way of examination) or omitting unnecessary units. The unit structure is a well-known, and it has been adopted in conventional microscopes, so detailed descriptions will be omitted. Incidentally, as to each of the eyepiece 17 and the object lens 14 in the microscope system 1, plural kinds of units with different magnification are prepared in advance so that the user can exchange them in accordance with requirements.

The units in the above-described microscope system 1 are imparted with respective predetermined conducting abilities, which are classified into four types in accordance with their abilities, that is, high conducting ability A, medium conducting ability B, low conducting ability C and general conducting ability D. In FIG. 2, alphabetical signs A to D assigned to each of the unit refer to the conducting ability types of the units. It should be noted that in this specification and the attached claims, the term “conducting ability of a unit” refers to the conducting ability of the surface of the unit. Namely, it does not refer to the conducting abilities of various optical systems, electrical circuits or mechanical arrangements incorporated in the unit.

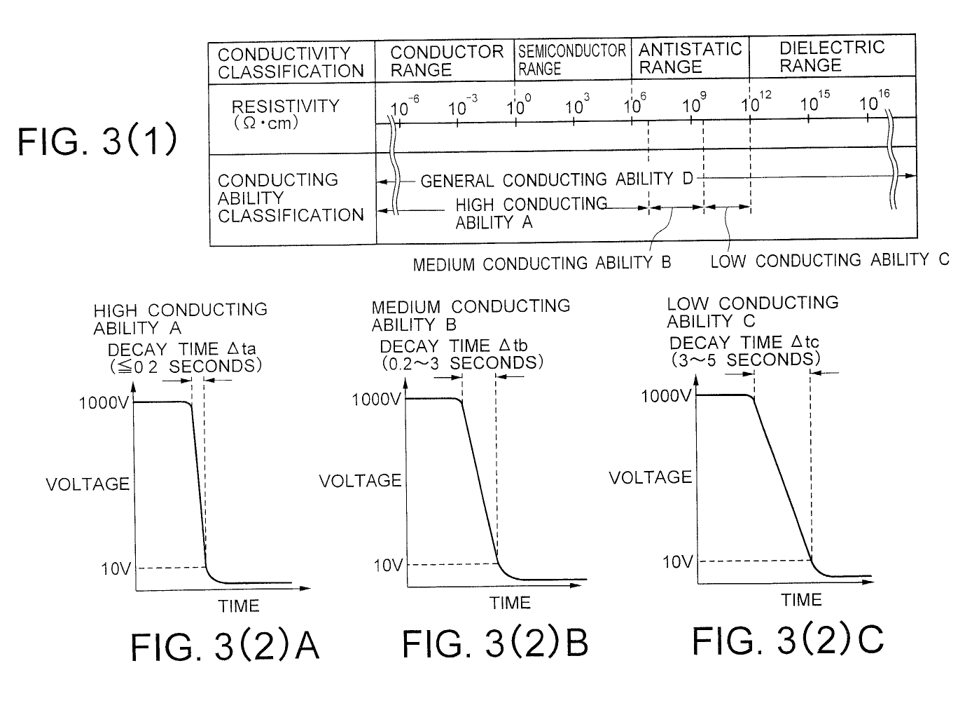

FIGS. 3(1), 3(2)A, 3(2)B and 3(2)C are diagrams explaining conducting abilities of the units. It is known that the conductivities of materials are generally classified into four ranges, that is, from high conductivity to low, a conductor range (with resistivity less than 10Ω·cm), a semiconductor range (with resistivity from 10 to 10⁶Ω·cm), an antistatic range (with resistivity from 10⁶ to 10¹²Ω·cm) and a dielectric range (with resistivity more than 10¹²Ω·cm). It is also well-known which kinds of materials will provide respective the conductivities. For example, as is well known, materials that provide conductivities in the conductor range are silver, copper, aluminum, nickel, iron, platinum, lead and mercury etc.

As shown in the lower row of FIG. 3(1), the higher the conductivity of a material is, the higher conducting ability the material shows. FIGS. 3(2)A, 3(2)B and 3(2)C are the graphs specifically showing the characteristics of the high conducting ability A, medium conducting ability B and low conducting ability C. As will be seen from these graphs, the high conducting ability A is the ability with the decay time Δ ta less than 0.2 seconds, the medium conducting ability B is with the decay time Δ tb from 0.2 to 3 seconds and the low conducting ability is with the decay time Δ tc from 3 to 5 seconds.

Since ordinary electronic components are very rarely broken with a charge corresponding to about 10 (or several) volts, the classification of conducting abilities into high, medium, low and general conducting abilities (designated with A, B, C and D respectively) is made in accordance with the length of decay time measured upon application of 1000 volts by generation of static electricity until the internal potential is reduced to 10 volts under the grounded state. The general conducting ability D is a conducting ability with the decay time Δ td falling within the range 0 to ∞.

As will be clearly seen from FIGS. 3(1), 3(2)A, 3(2)B and 3(2)C, the conducting ability A, conducting ability B and conducting ability C except for the conducting ability D have a conducting ability that is not zero, so they can reduce the potential to 0 volt in the end, when sufficiently long time have lapsed.

Now returning to FIGS. 1 and 2, each of the units of the microscope system 1 is required to be imparted with such an optimized conducting ability that the sample to be examined 101A is protected from electrostatic break and static electricity generated in respective units is certainly directed to the ground line 201 to give a electrostatic break preventing function to the microscope 10 as a whole. The conducting ability of each unit that is optimized to realize the above condition is determined based on its positional relationship with the sample to be examined.

[On Low Conducting Ability C]

First, in order to prevent from the sample to be examined 101A from being subject to the electrostatic break, the unit that is in contact with the sample to be examined 101A, namely holder 13c must inhibit abrupt current flow from the microscope body 12 to the sample to be examined 101A and abrupt current flow from the sample to be examined 101A to the microscope body 12. In addition, it is desirable that the holder 13c have such a conducting property that directs the charge generated in the holder 13cto the ground line 201 reliably.

Therefore it is desirable that the holder be imparted with low conducting ability C (shown in FIG. 3(2)C).

[On High Conducting Ability A]

Secondly, it is desired that the units to which the examiner is highly likely to touch (which corresponds to movable units referred to in the attached claims, namely the units that are constructed as adjustable or movable such as the eyepiece 17, barrel 18, illumination device 16, microscope body 12, revolver 15, object lens 14 and stage unit 11 etc.) be constructed to cause electric charge, as it is generated in the units, to flow directly into the ground line 201 without passing through the sample to be examined 101A so as not to allow residual charge. That is because if charge remains in a unit, the charge would be given from that unit to the sample to be examined 101A via another unit to possibly cause the electrostatic break of the sample.

Therefore, it is desirable that the eyepiece 17, barrel 18, illumination device 16, microscope body 12, revolver 15, object lens 14 and stage unit 11 be imparted with high conducting ability A (shown in FIG. 3(2)A).

[On General Conducting Ability D]

No condition is required for the conducting abilities of the units of which a possibility of being touched by the examiner is low (e.g. the camera unit 19, a rear panel 12a attached to the back side of the microscope body 12, a bottom panel 12b secured to the bottom of the microscope body 12, and an illumination lamp 16a attached to the illumination device 16), since the possibility of the generation of static electricity in these units is also low. Namely, the camera unit 19, rear panel 12a, bottom panel 12b, illumination lamp 16a may be imparted with any conducting ability that belong to the general conducting ability D (shown in FIG. 3(1)).

Therefore, the materials for these units can be selected from materials available at low prices irrespective of their conducting abilities, so that the cost for realizing the electrostatic break preventing function of the microscope apparatus 10 can be reduced.

In the embodiment described above, each of the units of the microscope system 1 is imparted with appropriate conducting ability. Thus in this arrangement, electric charge generated in the sample to be examined 101A flows into the stage unit 11 slowly via the holder 13c imparted with low conducing ability C, and then into the ground line 201 rapidly via the stage unit 11 and the microscope body 12 both of which are imparted with high conducting abilities A. As a result the electrostatic break of the sample to be examined 101A can be prevented with reliability.

Furthermore, in this embodiment, each unit can be grounded through only single one ground line 201, since not only the ground line 201 but also the conducting abilities of the units and the electrical connections contribute to realize the electrostatic break preventing function. Therefore, troublesome task of connecting many ground lines and the risk of entangling the examiner's hand or leg in ground lines can be reduced.

<Second Embodiment>

Next, the second embodiment of the invention will be described with reference to FIGS. 1 and 2.

In the above-described microscope system 1 according to the first embodiment, the electrostatic break preventing function required for the microscope apparatus 10 varies depending on the electrostatic tolerance of the sample to be examined 101A.

So in this embodiment, in the microscope system 1 same as the above-described first embodiment, a plurality of units with the same structure are prepared for the unit that is to be in contact with the sample to be examined, and different conducting abilities are imparted to these plurality of units.

For example, in addition to a holder 13c imparted with low conducting ability, holders 13a and 13b having the structure same as the holder 13c are prepared, and high conducting ability A and medium conducting ability B are imparted to the holders 13a and 13b respectively (see FIG. 3(2)B).

As a result, if the sample to be examined 101A is changed, the user can always give an optimized electrostatic break prevention function to the microscope apparatus 10 by selecting one of the holders 13a, 13b and 13c in accordance with the requirement. Namely, the microscope system 1 of this embodiment can be accommodated to electrostatic tolerances of respective samples to be examined flexibly and with reliability.

<Third Embodiment>

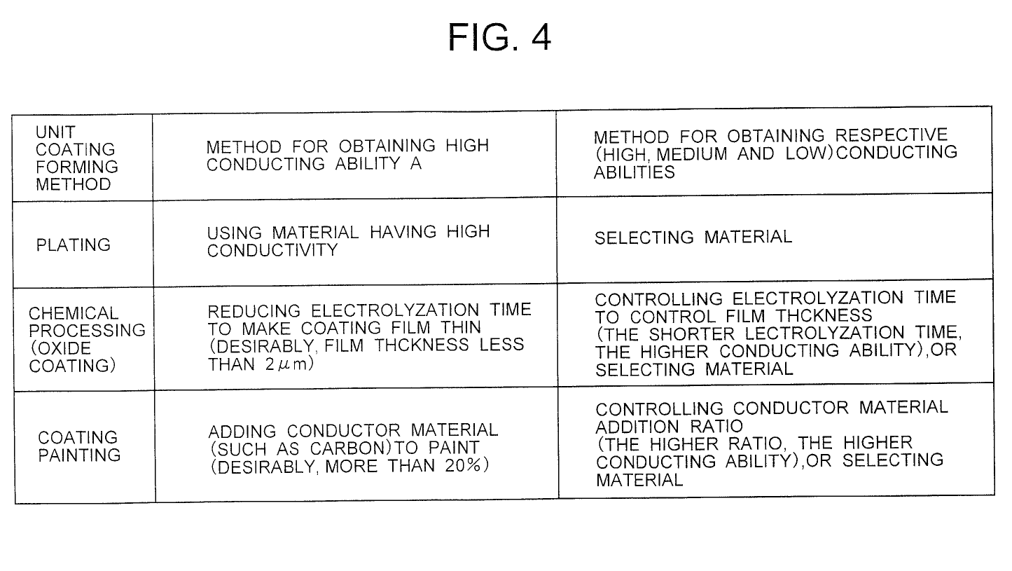

In the following, the third embodiment of the invention will be described with reference to FIG. 4.

As the third embodiment, a method of manufacturing the units of the microscope system 1 according to the first and second embodiments described above will be described.

Each of the units of the microscope system 1 comprises an element (such as an optical system, electric circuit, or mechanical arrangement etc.) for making the microscope system 1 to function and unit body which houses that element. Since each of the elements of the units are the same as the elements of conventional microscopes 100, detailed descriptions of the elements are omitted.

The unit bodies are manufactured by conventional process such as casting using metals like light alloy of aluminum or brass as their materials. Then, unit coating (film) is formed on the surface of the unit bodies for rust prevention or external decoration by a well-known method such as plating, chemical processing or painting.

In this connection, units of the conventional microscopes are formed with relatively thick (more than 2μm) oxide film such as anodized aluminum film as unit coating, so they have little conducting abilities. Furthermore, in the conventional microscope apparatus, conducting abilities of the units are substantially uniform.

On the other hand, in this embodiment, conditions for forming the unit coating are different from the conventional conditions, since it is required to provide high conducting ability A, medium conducting ability B and low conducting ability C. In addition, in this embodiment the coating film forming conditions for respectively obtaining high, medium and low conducting abilities A, B and C are different from each other.

However, the film forming condition for obtaining general conducting ability D may be either same as or different from conventional conditions. For example, dielectrics such as plastics or conductors such as metals may be used as coating materials. Namely it would be preferable to form coating at low cost without paying attention to the conducting abilities.

FIG. 4 is a table for explaining methods for obtaining respective conducting abilities.

First, it should be noted that as mentioned above, formation of unit coating is performed by one of the plating, chemical processing and painting.

In this embodiment, when it is required to obtain high conducting ability A, in the case of plating, conductor materials are used as plating materials. In the case of chemical processing, electrolyzation time at the time of oxide (such as anodized aluminum) film formation is made relatively short as compared with conventional cases to suppress the film thickness to less than 2μm. In the case of painting, conductor materials (such as carbon) are added to the paint (desirably, more than 20%).

In this embodiment, in order to obtain respective conducting abilities (i.e. high conducting ability A, medium conducting ability B and low conducting ability C) the following control of coating film forming conditions is performed, that is: in the case of plating, selecting a material to be used; in the case of chemical processing, changing electrolyzation time to control coating film thickness (the thickness corresponding to high, medium and low conducting abilities A, B and C should be gradually increased in the mentioned order, namely, the higher the conducting ability is required to be, the larger the thickness should be made); and in the case of painting, controlling conductor material addition ratio (the addition ratio corresponding to high, medium and low conducting abilities A, B and C should be gradually decreased in the mentioned order, namely, the higher the conducting ability is required to be, the lower the ratio should be made).

As a result, it is possible to impart a predetermined conducting ability to each of the units shown in FIGS. 1 and 2, so that the microscope systems according to the first and second embodiments can be realized with reliability.

Incidentally, as to the chemical processing and painting, the control of coating film forming conditions is not limited to the above method, but the control may be performed by selecting the material to be used therefor.

As mentioned above, in obtaining the high conducting ability A by the chemical processing method, the unit coating film less than 2μm is preferable. This is because it is known that the film thickness less than 2μm allows the conduction between the unit body (which is made of conductor) and the outside through the unit coating. In addition, the thicker the unit coating film is made, the longer the time required for the conduction will be, so the respective conducting abilities (i.e. high, medium and low conducting abilities A, B and C) can be obtained only by controlling the film thickness. In this connection, the chemical processing is particularly suitable as a method for obtaining a predetermined conducting ability, since the film thickness control in the chemical processing can be easily realized by varying the electrolyzation time,

Although it is described in the above that in obtaining the high conducting ability A by the painting method, addition of conductor materials (such as carbon) more than 20% is preferable, the value 20% is only a guide. For example, in the case of carbon addition, the conducting abilities imparted to units are considered to vary to some extent depending on whether the carbon is fibriform (filament) or powder.

The higher the conducting ability should be, the longer electrolyzation time or the higher conductor material addition ratio is required. So the higher conducting ability tends to involve the higher cost. Therefore, the wasteful cost might be restricted by reducing the conducting ability to be imparted to each unit and the number of the units imparted with conducting ability to minimum.

<Others>

In the first embodiment, the sample to be examined 101A is attached to the holder 13c so as to be set on the stage. But if the sample to be examined is to be placed directly on the stage, it is preferable that the conducting ability of the stage 11 be set to the low conducting ability C.

Although in the first and second embodiments described above, the number of types of the conducting abilities was four (i.e. high, medium, low and general conducting abilities A, B, C and D), the number of types of the conducting abilities may be changed in accordance with the number of types of the samples to be examined 101A or the state of use (or way of customization) of the microscope apparatus 10.

Although three types of holders (13a, 13b and 13c) are prepared in the second embodiment, the number of types of holders may be varied. If the number of types of the holders is increased, they can be more flexibly adapted to the electrostatic tolerance of the sample to be examined 101A.

In the second invention, the holders 13a and 13b are prepared as replacement (or interchangeable) units. But a replacement unit having a structure same as a unit other than the holder with conducting ability different from that unit may be prepared. For example, it is possible to prepare a plurality of units that have the structures same as the stage unit 11 and conducting abilities different from the stage unit 11 (e.g. a replacement stage unit having medium conducting ability B and a replacement stage unit having low conducting ability C). In this case, in a case in which a sample to be examined 101A is attached to the holder, the stage 11 as described in the second embodiment will be used, while in a case in which the sample to be examined is placed on the stage 11 directly, the replacement stage with low conducting ability C will be used. Thus appropriate electrostatic break preventing function can be given to the microscope 10 appropriately by selecting a stage unit to be used in accordance with the manner of setting on the stage, of the sample to be examined 101A.

Alternatively, a plurality of replacement stage units that are the same as the stage unit 11 in their structures but different from the stage unit 11 in their conducting abilities of the upper plate thereof can be prepared so that one of the stage units may be appropriately used in accordance with the situation.

Although in the third embodiment, the coating film forming conditions are controlled so as to impart a predetermined conducting ability to each of the units, the same conducting ability can be imparted to the unit by selecting the kind of material to be used for the unit body, controlling the mixing ratio of a conductor material and non-conductor material for the material unit body material, or selecting kinds of conductor and non-conductor material to be mixed for the unit body material.

In the third embodiment, materials other than those mentioned above can be used or mixed as long as they can impart similar conducting abilities to the units.

It should be noted that the ground line 201 used in the first and second embodiments is provided for bringing static electricity (or charge) to the ground, so it is different from those electric ground lines which are provided in electric circuits or the like built in the units for preventing an electric shock or noises. Therefore it is not possible to use the ground line 201 and the electric ground lines in the electric circuits in common. In the first and second embodiments, the electric ground lines can be omitted.

Although, in the first and second embodiments, the ground line 201 is connected to the microscope body 12, it may be connected to another unit of the microscope apparatus 10 that has conducting properties so long as it is possible to give desired electrostatic break preventing function to the microscope apparatus.

What is claimed is:

1. A microscope comprising:
a body unit that constitutes a microscope body;
a plurality of units that are attached to the body unit and electrically connected to a ground line;
wherein at least two of said units have conducting properties with conducting abilities different from each other.

2. A microscope according to claim 1, wherein the microscope comprises a support unit which supports a sample to be examined, as one of said plurality of units, said supporting unit being one of said two units having conducting properties, wherein the conducting ability of said support unit is lower than that of the other unit.

3. A microscope according to claim 2, wherein said support unit is a holder which holds said sample to be examined, wherein the holder has a conducting ability with a decay time falling within the range of 0.2 to 5 seconds and said other unit has a conducting ability with a decay time not more than 0.2 second.

4. A microscope according to claim 1, wherein the microscope comprises a movable unit which is adapted to be adjustable or detachable, as one of said plurality of units, said movable unit being one of said two units having conducting properties, wherein the conducting ability of said movable unit is higher than the other unit.

5. A microscope according to claim 1, wherein said two units having conducting properties are electrically connected to each other and the ground line is electrically connected to only one of said two units.

6. A microscope system including a microscope that comprises a body unit and a plurality of units attached thereto, said plurality of units including a support unit which supports a sample to be examined, the system further comprising a replacement unit having a structure same as said support unit, wherein said support unit and said replacement unit have conducting properties with conducting abilities different from each other.

7. A method of manufacturing microscope units for manufacturing said two units having conducting properties with conducting abilities different from each other as recited in claim 1, comprising:
making unit bodies of said two units through a predetermined process; and
imparting conducting abilities to said two units; wherein the conducting abilities of the two units are made different from each other by one of the following manners:
selecting kinds of conductor materials used for the unit bodies;
selecting kinds of conductor materials used for coatings of the unit bodies;
controlling a mixture ratio of a conductor material and a non-conductor material to be mixed to materials of the unit bodies;
controlling a mixture ratio of a conductor material and a non-conductor material to be mixed to materials of coatings of the unit bodies;
selecting kinds of conductor material and non-conductor material to be mixed to materials of the unit bodies;
selecting kinds of conductor material and non-conductor material to be mixed to materials of coatings of the unit bodies; and
controlling thickness of coatings of unit bodies.
